(19) United States
(12) Patent Application Publication
(10) Pub. No.: US 2017/0103370 A1
(43) Pub. Date: Apr. 13, 2017

(54) IN-BRANCH FINANCIAL INSTITUTION CALEDNARING SOLUTION

(71) Applicant: DIEBOLD, INCORPORATED, North Canton, OH (US)

(72) Inventors: David KUCHENSKI, Tallmadge, OH (US); Devon WATSON, Canal Fulton, OH (US)

(73) Assignee: DIEBOLD, INCORPORATED, North Canton, OH (US)

(21) Appl. No.: 15/311,061

(22) PCT Filed: May 12, 2015
(86) PCT No.: PCT/US15/30343

§ 371 Date: Dec. 9, 2016

Related U.S. Application Data
(60) Provisional application No. 61/991,931, filed on May 12, 2014.

(51) Int. Cl. G06Q 10/10; G06Q 30/02

(52) U.S. Cl. CPC G06Q 10/1095; G06Q 30/0203

(57) ABSTRACT

In an example embodiment, a financial institution calendaring solution that allows a consumer to schedule an appointment for a resource (for example a person who can assist with a particular type of transaction such as a mortgage loan, car load, investment advice, etc.) at a particular location. The consumer is provided with a list of available times for the resource at the location. The consumer selects a time and an appointment is scheduled. Some embodiments are directed to an application for a consumer device and other embodiments are directed to financial institution calendaring logic that communicates with the consumer device.

### CROSS REFERENCE TO RELATED APPLICATIONS

This Application is a U.S. National Stage Application of and claims priority to and the benefit of International Patent Application PCT/US15/030343 filed on May 12, 2015 and through which claims priority to and the benefit of Provisional U.S. Patent Application 61/991,931 filed on May 12, 2014, both of which are herein incorporated by reference in their entirety.

### TECHNICAL FIELD

The present disclosure relates generally to allowing consumers to schedule resources with a financial institution.

### BACKGROUND

Financial Institutions provide many different services, such as mortgages, car loans, and investment advice. However, individual employees of the financial institution may specialize. For example a mortgage loan officer may not give investment advice and visa versa. This can be a burden for a consume trying to schedule a meeting for a particular service.

### BRIEF DESCRIPTION OF THE DRAWINGS

The accompanying drawings incorporated herein and forming a part of the specification illustrate the example embodiments.

FIG. 1 is a block diagram illustrating an example of a consumer device communicating with a financial institution calendaring system.

FIG. 2 is a block diagram illustrating an example of a consumer device upon which an example embodiment can be implemented.

FIG. 3 is a block diagram illustrating an example of a financial institution scheduling service that allows a consumer to schedule an appointment with a resource at the financial institution.

FIG. 4 is a block diagram illustrating an example of a financial institution hierarchy for providing financial services.

FIG. 5 is a block diagram illustrating a detailed example of a consumer scheduling a resource at a financial institution.

FIG. 6 illustrates an example of a user interface for scheduling appointments with a resource associated with a financial institution.

FIG. 7 illustrates an example of a user interface for selecting a type of appointment.

FIG. 8 illustrates an example of a user interface for selecting a time for the appointment.

FIG. 9 illustrates an example of a user interface for providing notes for the appointment.

FIG. 10 illustrates an example of a user interface confirming an appointment.

FIG. 11 illustrates an example of a user interface for selecting a location.

FIG. 12 illustrates an example of a user interface displaying scheduled appointments.

FIG. 13 illustrates an example of a user interface for indicating arrival at a scheduled appointment.

FIG. 14 illustrates an example of a user interface for requesting a survey for an appointment.

FIG. 15 illustrates an example of a user interface for responding to a survey.

FIG. 16 is a block diagram illustrating an example of a computer system upon which an example embodiment may be implemented.

FIG. 17 is a block diagram illustrating an example of a methodology performed by a consumer device for scheduling an appointment with a resource at a financial institution.

FIG. 18 is a block diagram illustrating an example of a methodology performed by a financial institution for scheduling an appointment with a resource at a financial institution.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In an example embodiment, a financial institution calendaring solution that allows a consumer to schedule an appointment for a resource (for example a person who can assist with a particular type of transaction such as a mortgage loan, car load, investment advice, etc.) at a particular location. The consumer is provided with a list of available times for the resource at the location. The consumer selects a time and an appointment is scheduled. Some embodiments are directed to an application for a consumer device and other embodiments are directed to financial institution calendaring logic that communicates with the consumer device.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

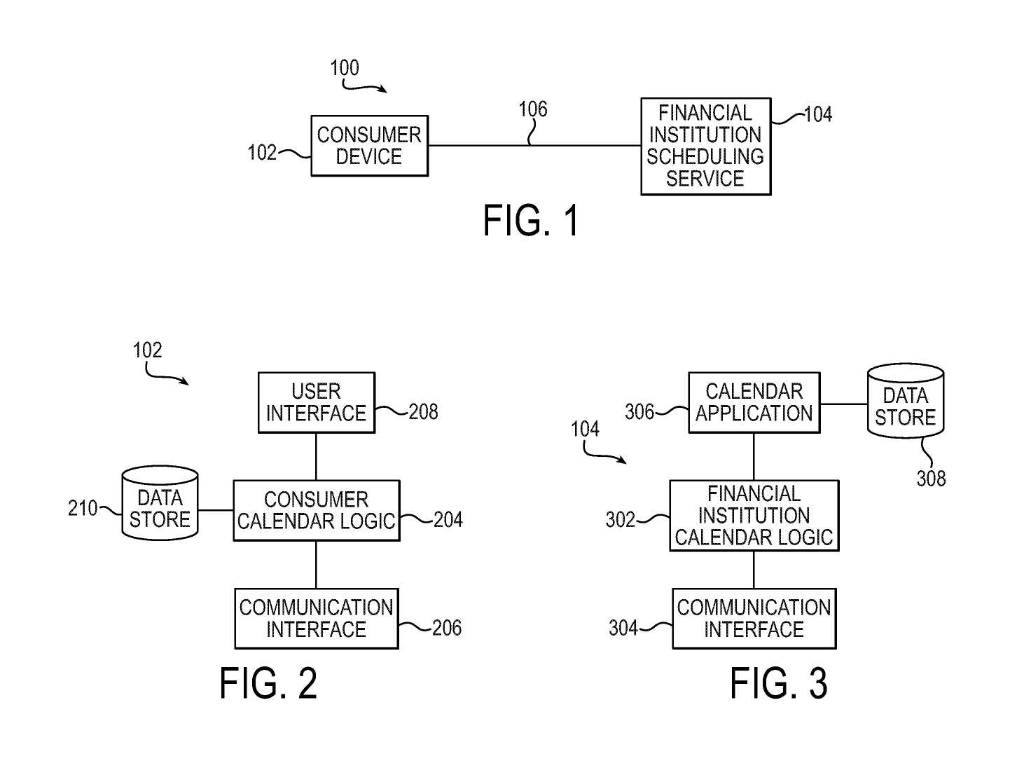

FIG. 1 is a block diagram illustrating an example 100 of a consumer device 102 communicating with a financial institution calendaring system 104 over a link 106. The consumer device 102 may be any suitable type of device, such as, including but not limited to, a personal computer, a mobile device such as a laptop computer, a personal digital assistant (PDA), a tablet computer, or smart phone, or any other device suitable for communicating with the financial institution scheduling service. As will be described in more detail infra, the financial institution scheduling system 104 may be any suitable calendaring application. The link 106 may be any suitable type of communication link. For example, link 106 may be a wired link, a wireless link, multiple wired links, multiple wireless links, or a combination of wired and wireless links.

In an example embodiment, a consumer operating the consumer device 102 selects an application for communicating with the financial institution scheduling service 104. The consumer may have pre-selected a default location or may select a location. A request is made for an appointment by the consumer employing the consumer device 102. The consumer mobile device 102 forwards the request and the location to the financial institution scheduling service 104. The financial institution scheduling service 104 determines services that are available for the specified location and sends a list of services available to the consumer device 102. As will discussed in further detail herein, the consumer device 102 outputs the list of available service and allows the consumer to select a desired service. The consumer device 102 sends the selected service to the financial institution scheduling service 104. The financial institution scheduling service 104 determines times that a resource (e.g., a representative) is available for the selected service. In particular embodiments, more than one resource may be able to handle the selected service in which case the financial institution scheduling service 104 will determine available times for the resources able to handle the selected service. The financial institution scheduling service 104 sends the available times to the consumer device 102. The consumer device 102 outputs the available times allowing the consumer select a times. Upon selection of a time, the consumer device 102 sends data representative of the selected times to the financial institution calendaring service 104. In response to receipt of the selected times, the financial institution calendaring service 104 scheduled the appointment. If more than one resource is available for the selected times, the financial institution scheduling service 104 will select one of the available resources. Any suitable method can be employed for selecting an available resource (e.g., randomly, alphabetical order, by seniority, etc.).

In an example embodiment, the financial institution scheduling service 104 sends a confirmation to the consumer device 102. The consumer device 104 may be operable confirmation to store the appointment, and output the confirmation via a user interface.

In an example embodiment, the consumer device 102 may allow the consumer to add notes to the appointment. Data representative of the notes is sent by the consumer device 102 to the financial institution scheduling service 104 which can associate the notes with the scheduled appointment.

In an example embodiment, the consumer may be employ consumer device 102 to indicate the consumer has arrived for the scheduled appointment. The consumer device 102 will send data indicating the consumer has arrived for the appointment to the financial institution scheduling service 104 which can cause a message to be sent to the selected resource.

In an example embodiment, the financial institution scheduling service 104 may send a survey to the consumer device 102 to acquire comments about the service provided at the scheduled appointment. The consumer may fill out the survey and have the consumer device 102 send the completed survey to the financial institution scheduling service 104.

In an example embodiment, a consumer may employ the application on the consumer device 102 to cancel a scheduled appointment. The consumer device 102 sends notification of the cancelation to the financial institution scheduling service 104. The financial institution scheduling service 104 removes the appointment from the calendar of the selected resource in response to receiving the notification of cancelation from the consumer device 104.

FIG. 2 is a block diagram illustrating an example of a consumer device 102 upon which an example embodiment can be implemented. The consumer user device 102 comprises consumer calendar logic 204, a communication interface 206, a user interface 208, and a data store 210. The consumer calendar logic 204 is coupled with the communication interface 206, user interface 208 and data store 210 and performs the functionality for the consumer device 102 described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that performs the desired functionality when executed by a processor.

In an example embodiment, consumer calendar logic 204 is operable to communicate with a financial institution (e.g., financial institution scheduling service 104 in FIG. 1) to schedule an appointment for a resource via the communication interface 206. The communication interface 206 may be any suitable wired or wireless interface suitable for communicating on communication link 106 (FIG. 1).

The user interface 208 may be any suitable interface for communicating with a user. For example, the user interface may employ a display and a keypad, a touch screen, and/or an audio output or input (e.g., voice recognition).

In an example embodiment, the consumer calendar logic 204 is operable to obtain data representative of a selected location from the financial institution. The selected location may have been previously selected and stored in data store 210 (e.g., a default location), or the consumer calendar logic 204 may request the financial institution send a list of available locations.

The consumer calendar logic 204 is further operable to request a list of available services from the financial institution. The consumer calendar logic 204 causes data representative of the list of available services to be output on the user interface 208 and receives data representative of a selection from the list of available services from the user interface 208. The consumer calendar logic 204 sends the data representative of the selected (requested) service to the financial institution.

The consumer calendar logic 204 is operable to receive from the financial institution a time or plurality of times a resource is available for the requested service. The consumer calendar logic 204 causes the user interface 208 to output the times. The consumer calendar logic 204 is operable to obtain data representative of a selected times selected from the times available for the requested service from the user interface 208. The consumer calendar logic 204 is operable to send data representative of the selected times to the financial institution.

In an example embodiment, the consumer calendar logic 204 is operable to store in a calendar application data representative of the selected times for the requested service at the selected location for the scheduled appointment in data store 210. In an example embodiment, the data store 210 may be associated with a calendaring application. For example the consumer calendar logic 204 may send a .ics file (a popular file format employed by many commercial calendaring applications) to the data store 210. The consumer calendar logic 204 may also store data representative of reminders into data store 210.

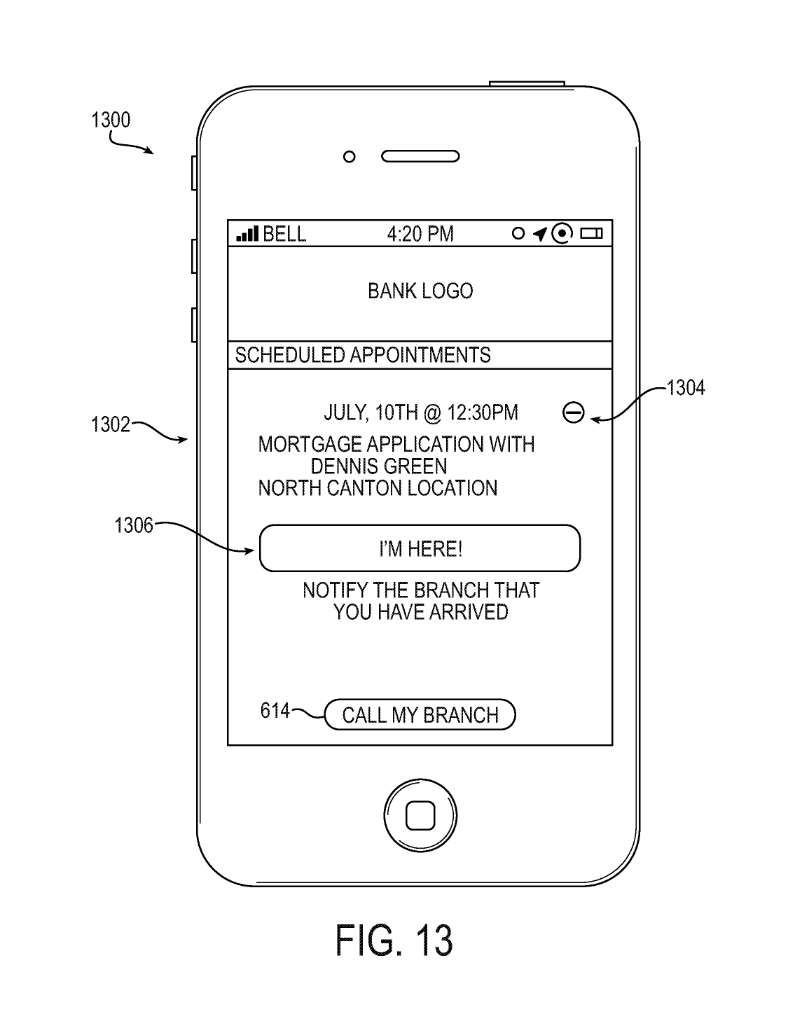

In an example embodiment, the consumer calendar logic 204 allows a consumer to send a message to the financial institution to check-in for the scheduled appointment. The user (or consumer) may open the application and using the user interface 208 select an option to indicate arrival for the scheduled appointment. The consumer calendar logic 204 is operable to send a notification to the financial institution indicating arrival for the scheduled appointment responsive to obtaining the data indicating the arrival for the scheduled appointment from the user interface 208. FIG. 13 illustrates an example of data display on a user interface for checking in. The

In an example embodiment, the consumer calendar logic 204 allows a consumer to cancel an appointment. The consumer calendar logic 204 is operable to obtain data indicating a cancelation of the scheduled appointment from the user interface 208. In response, the consumer calendar logic 204 is operable to send a notification of the cancelation of the scheduled appointment to the financial institution.

In an example embodiment, the consumer calendar logic 204 allows a user to provides notes for the appointment. For example, the consumer calendar logic 204 is operable to obtain data representative of notes for the scheduled appointment from user interface 208. The consumer calendar logic 204 is operable to send the data representative of the notes for the scheduled appointment to the financial institution.

In an example embodiment, the consumer calendar logic 204 is operable to receive a survey from the financial institution for the scheduled appointment. The consumer calendar logic 204 causes the survey to be output on the user interface 208. The consumer calendar logic 204 is operable to receive a response to the survey via the user interface 208 and sends the response to the financial institution.

FIG. 3 is a block diagram illustrating an example of a financial institution scheduling service 104 that allows a consumer to schedule an appointment with a resource at the financial institution. The financial institution scheduling service 104 comprises financial institution calendar logic 302, the functionality of which will be described herein. The financial institution calendar logic 302 is coupled with a communication interface 304 that allows the financial institution calendar logic 302 to communicate with consumer devices. The financial institution calendar logic 302 is further operable to communicate with a calendar application 306. The calendar application 306 may store appointments resources at the financial institution. In an example embodiment, the financial institution calendar logic 302 can obtain scheduling data from the calendar application 306 stored in a data store 308 associated with the calendar application, and is operable to store scheduled appointments into the data store 308.

In an example embodiment, the financial institution calendar logic 302 may provide a consumer device (e.g., consumer device 102 illustrated in FIGS. 1 and 2) with a list of available locations. This can allow a consumer to select a location. In particular embodiments, the selected location may be a default location for the consumer.

In an example embodiment, the financial institution calendar logic 302 is operable to receive from a consumer device (e.g., consumer device 102 in FIGS. 1 and 2) a selected location where a consumer would like to schedule an appointment. In response, the financial institution calendar logic 302 is operable to send data representative of available services for a selected location to the consumer device.

The financial institution calendar logic 302 is operable to obtain data representative of a requested financial service selected from the data representative of the available services for the selected location from the consumer device. The financial institution calendar logic 302 is operable to determine times where a resource is available for the requested service. The financial institution calendar logic 302 is further operable to send available times for the requested service to the consumer device.

The financial institution calendar logic 302 is operable to obtain from the consumer device a selected times from the times where resource is available for the requested service. The financial institution calendar logic 302 is operable to store in the data store 308 for the calendar application 306 data representative of the resource data representative of the selected times for the requested service at the selected location for the scheduled appointment. The financial institution calendar logic 302 may be further operable to send confirmation of the scheduled appointment to the consumer device.

In an example embodiment, the financial institution calendar logic 302 is operable to send email and text reminders for the scheduled appointment. In particular embodiments, the financial institution calendar logic 302 is operable to send a .ics file (described herein supra) to the calendar application for storing the scheduled appointment.

In an example embodiment, the financial institution calendar logic 302 is operable to select the resource from a plurality of resources available for the requested service during the selected times. The resource may be selected by any suitable technique. For example, the resource may be selected randomly, by seniority, by number of available times, etc.

In an example embodiment, the financial institution calendar logic 302 is operable to obtain data indicating an arrival for the scheduled appointment from the consumer device. In response to receiving the data indicating an arrival for the scheduled appointment, the financial institution calendar logic 302 may cause a message to be sent to the scheduled resource indicating arrival.

In an example embodiment, the financial institution calendar logic 302 is operable to receive data indicating a cancelation of the scheduled appointment from the consumer device. The financial institution calendar logic 302 is operable to remove the scheduled appointment from the calendar application 306 in response to receiving the data indicating the cancelation of the scheduled appointment from the consumer device.

In an example embodiment, the financial institution calendar logic 302 is operable to obtain data representative of notes for the scheduled appointment from the consumer device. The financial institution calendar logic 302 is operable to associate the data representative of the notes with the scheduled appointment to the financial institution.

In an example embodiment, the financial institution calendar logic is operable to send a survey to the consumer device for the scheduled appointment. The financial institution calendar logic is further operable to receive a response to the survey and store the response.

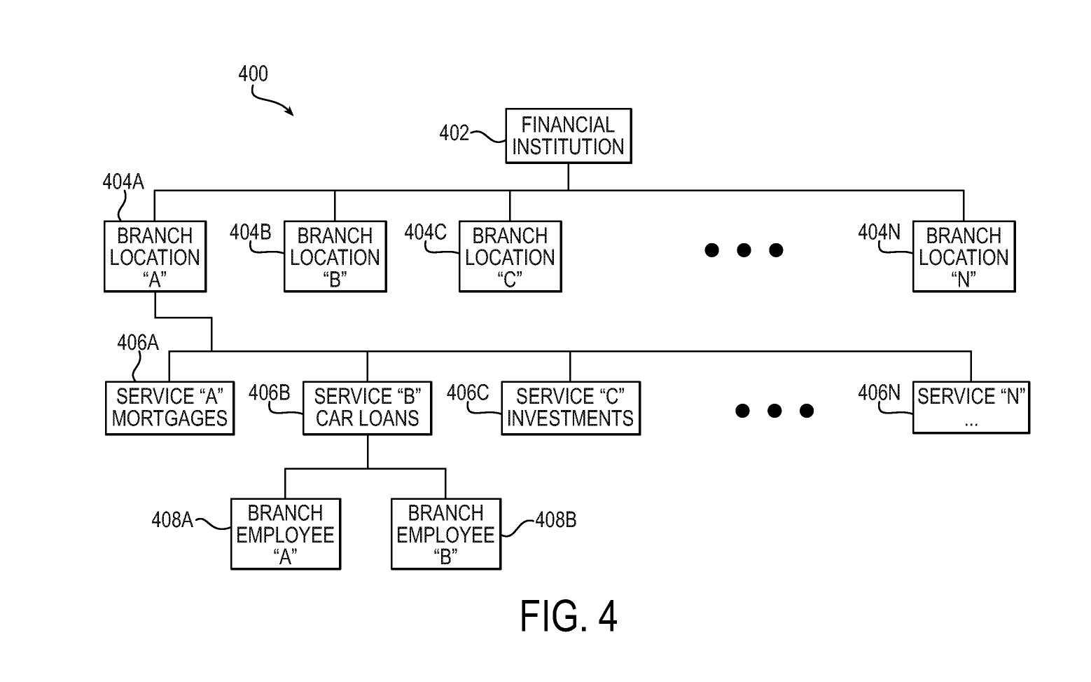

FIG. 4 is a block diagram illustrating an example of a financial institution hierarchy 400 for providing financial services. The financial institution 402 comprises at least one branch 404. As illustrated, the financial institution comprise a plurality of branches 404A, 404B, 404C . . . 404N, where N represents the number of bank branches and can be any physically realizable number. The branches have available services. In the illustrated example, Branch location “A” 404A has services 406A (Mortgages), 406B (car loans), 406C (investments), up to service 406 (service “N”, where N can represent any physically realizable number of services and can be any service). As those skilled in the art can readily appreciate the number and types of services provided may vary by branch, and the number of available resources for providing a particular service may also vary by branch. For example, at branch 404A, for service 406B (car loans) there are two branch employees 408A and 408B that can provide this service. Accordingly, the financial institution service logic 302 described in FIG. 302 is configurable so that an administrator affiliated with the financial institution can provide location data, service per location and resource per service per location separately for individual locations.

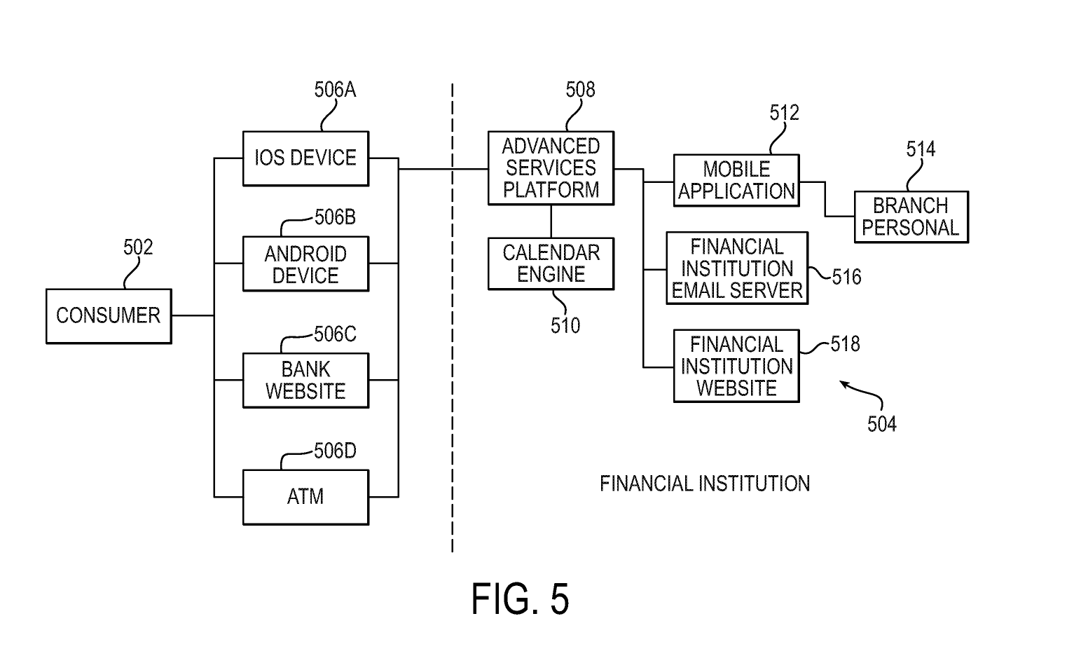

FIG. 5 is a block diagram illustrating a detailed example 500 of a consumer 502 scheduling a resource at a financial institution 504. The consumer may employ any suitable device 506 for communicating with the financial institution 504. For example, the consumer may employ an IOS device, an ANDROID device, access a website 506C, or employ an automated banking machine such as an automated teller machine (“ATM”) 506D. The consumer device 506 communicates with an advanced services platform 508 at the financial institution 504. The advanced services platform 508 may suitably comprise the financial institution scheduling logic 302 described in FIG. 3. The calendar engine 510 may suitably comprise the calendar application 306 described in FIG. 3.

In an example embodiment, the advanced services platform 508 is operable to communicate with the calendar engine 510 store scheduled appointments. In particular embodiments, the advanced services platform 508 is further operable to send notifications to a scheduled resource. For example, in the illustrated example, the advanced services platform sends messages via a mobile application 512 to branch personnel 514. However, as those skilled the art can readily appreciate, the advances services platform can use any suitable communication technology, such as, including but not limited to, the financial institution's mail server 516 or the financial institution's website 518.

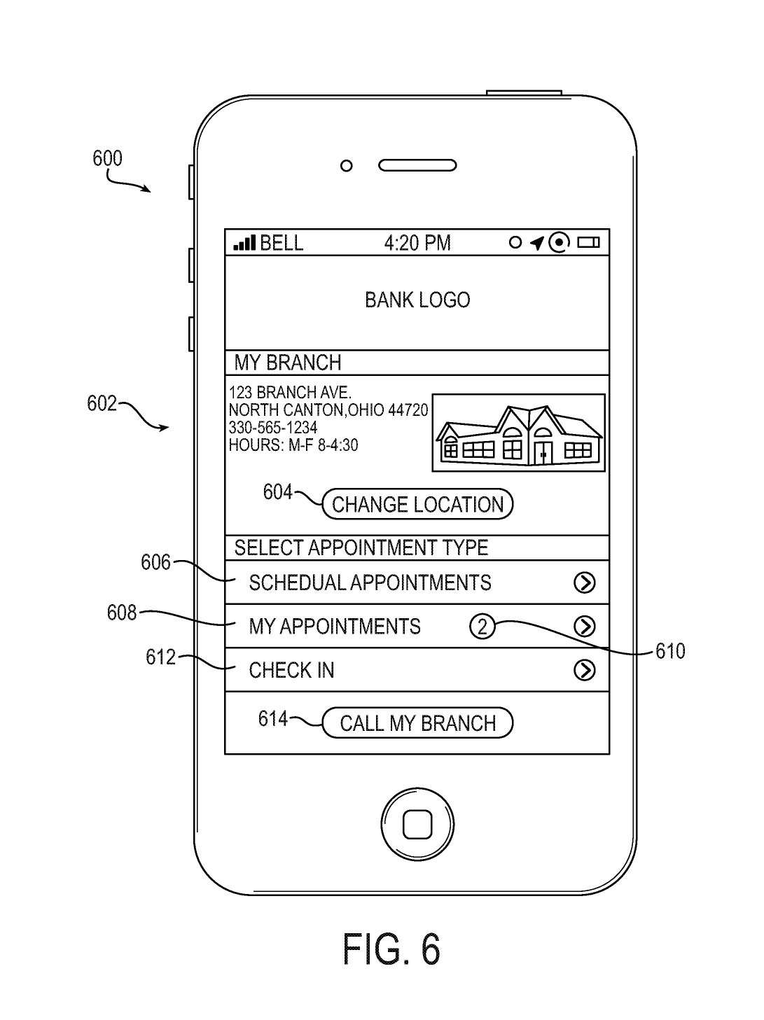

FIG. 6 illustrates an example of a user interface 600 for scheduling appointments with a resource associated with a financial institution. The user interface 600 comprises data representative of a selected branch 602 and provides an option 604 that allows a consumer to change the location. The user interface 600 also has an option 606 to schedule an appointment, an option 608 to view scheduled appointments, and an indicator 610 that provides data on how many appointments are pending (the indicator may also be in a selected color, such as red, to attract attention). The user interface 600 provides an option 612 to check in for an appointment and an option 614 to call the selected branch.

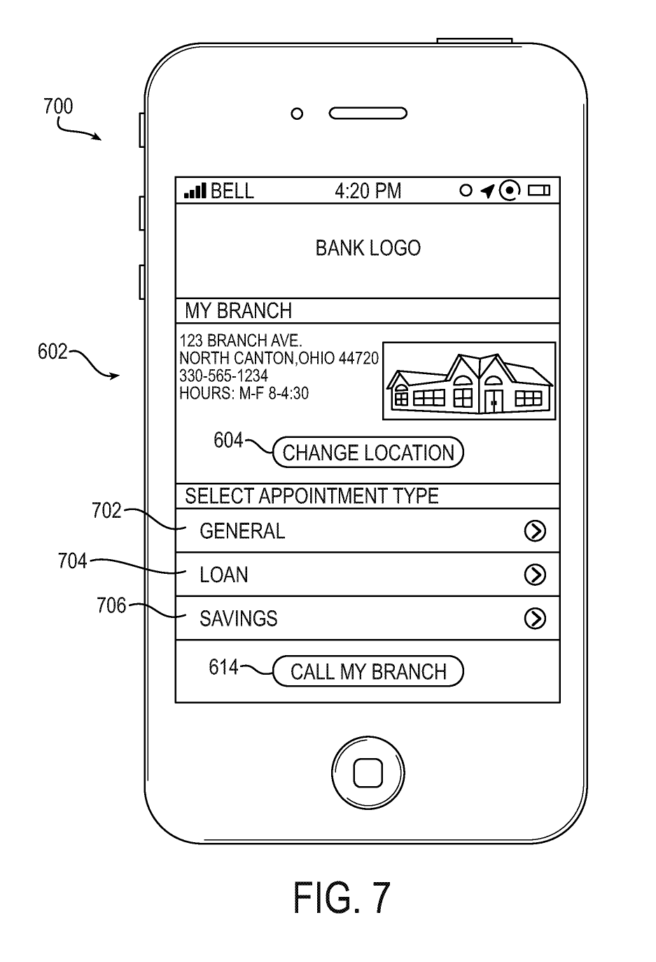

FIG. 7 illustrates an example of a user interface 700 for selecting a type of appointment. The user interface comprises an option 702 for scheduling a general appointment, an option 704 for scheduling an appointment for a loan (sub menus, not shown, may also be employed to specify a type of loan), and an option 506 for scheduling an appointment for a savings related transaction (sub menus, now shown, may be employed to specify the type of savings, e.g., passbook, certificate of deposit, etc.). These options are configurable by the financial institution.

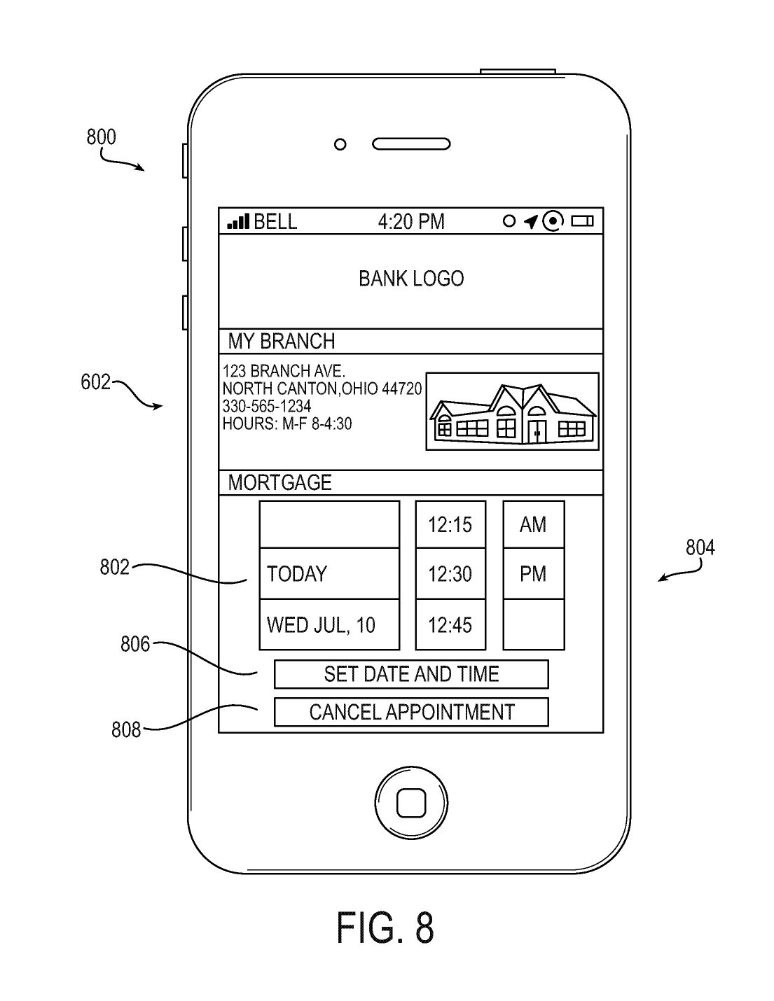

FIG. 8 illustrates an example of a user interface 800 for selecting a time for the appointment. The user interface 800 comprises an option 802 for selecting a date and an option 804 for selecting the time for the selected date. Because the financial institution sends available times, the user interface 800 can limit the display of date options 802 and time options 804 to when a resource is available. Dates and times when no resource is available will not be displayed. In particular embodiments, the user interface 800 provides an option 806 for setting the date and time and an option 808 to cancel the appointment.

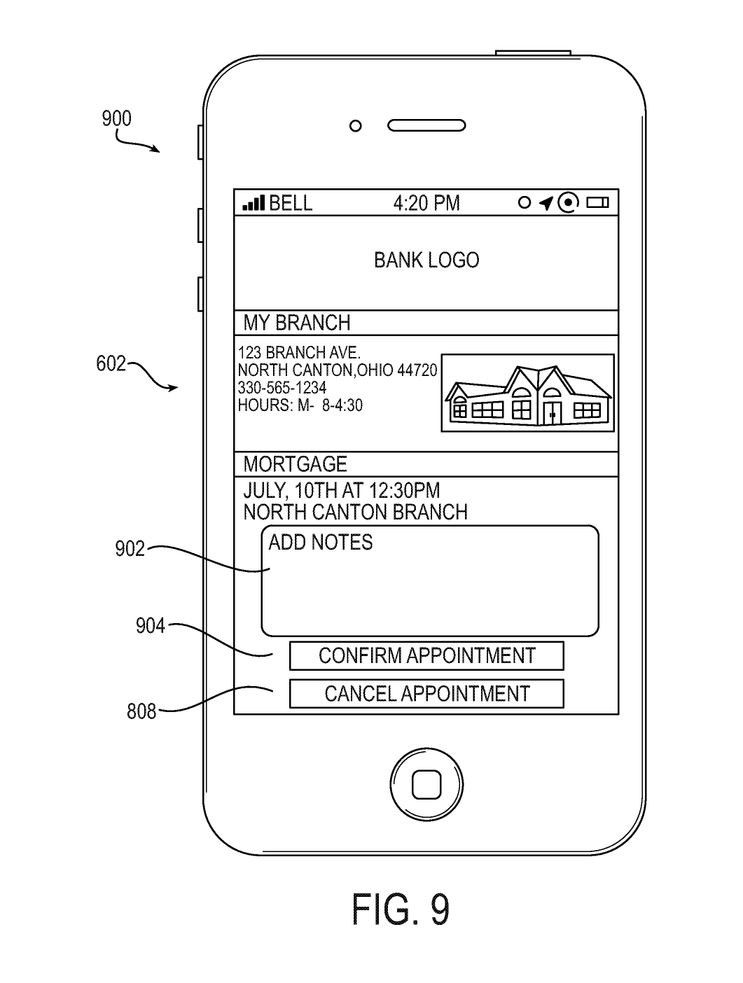

FIG. 9 illustrates an example of a user interface 900 for providing notes for the appointment. The consumer can employ area on the screen 902 for adding notes. Selecting the confirm appointment option 904 will cause the consumer device to send the notes to the financial institution.

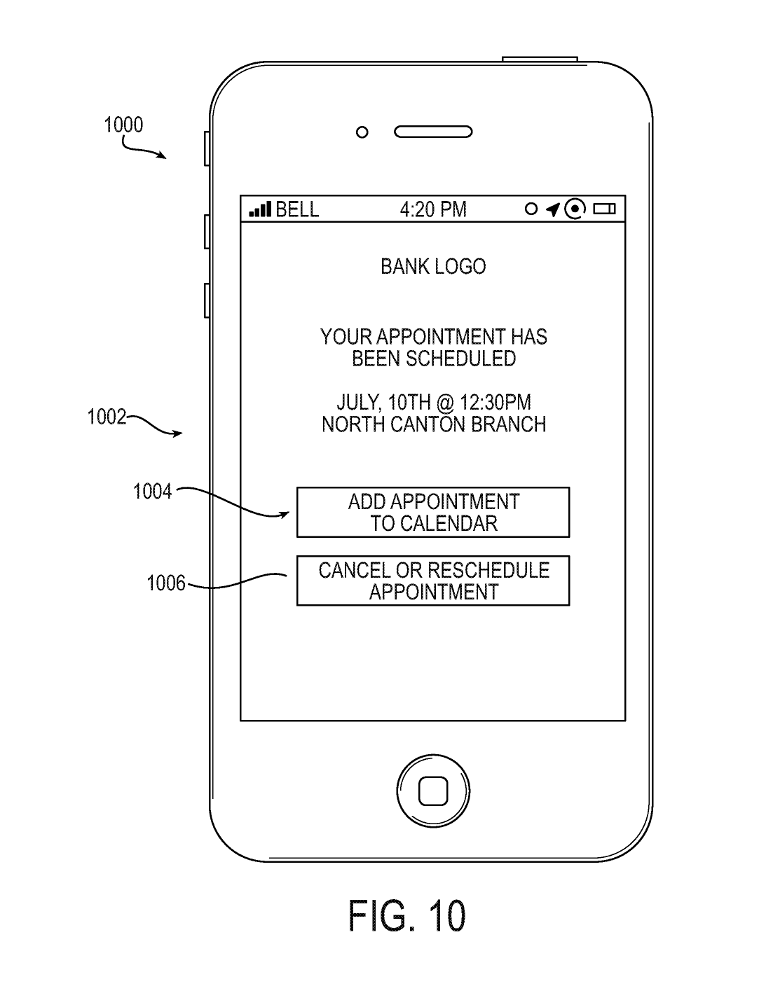

FIG. 10 illustrates an example of a user interface 1000 confirming an appointment. Data representative of the appointment 1002 is displayed on the user interface 1000. The user interface 1000 further provides an option 1004 to add the scheduled appointment to a calendar associated with the user device and an option 1006 to change or cancel the appointment.

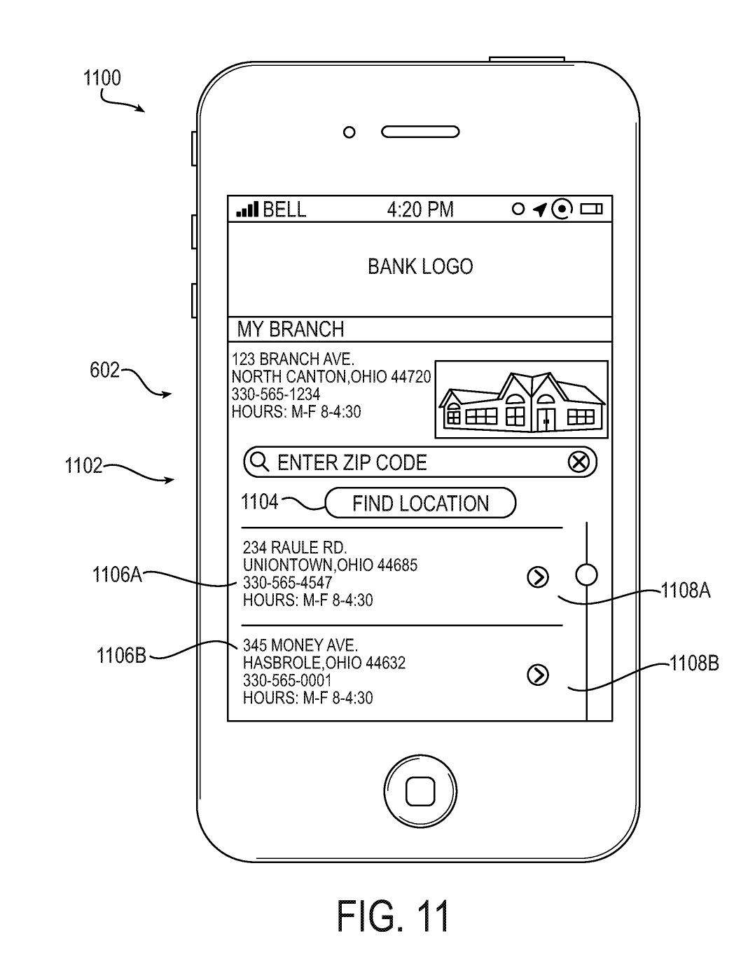

FIG. 11 illustrates an example of a user interface 1100 for selecting a location. The user interface 1100 has an option 1102 for entering a zip code. In particular embodiments, an global positioning system (GPS) can be employed to locate branches in proximity to the device's current location. A list of branches 1106 is provided and the user may select a branch by selecting an arrow 1108 associated with the branch.

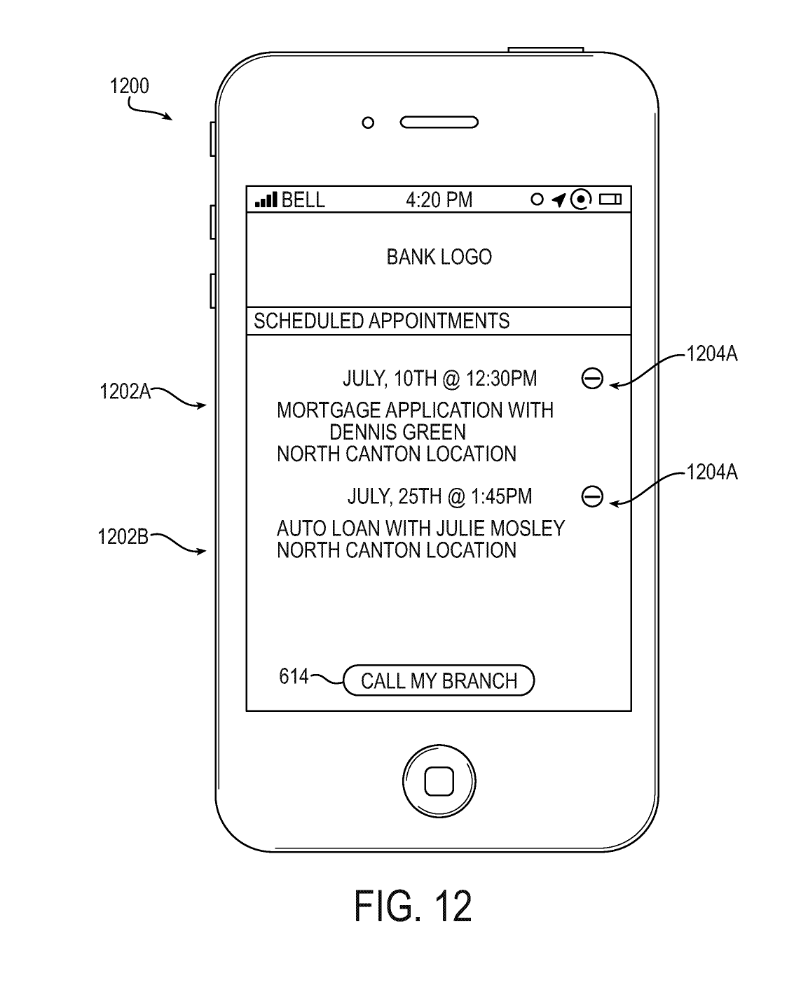

FIG. 12 illustrates an example of a user interface 1200 displaying scheduled appointments. The scheduled appointments 1202A, 1202B are displayed along with buttons 1202A, 1204B that allow the user to cancel appointments 1202A, 1202B respectively.

FIG. 13 illustrates an example of a user interface 1300 for indicating arrival at a scheduled appointment. Data representative of the appointment 1302 is displayed and an option 1304 is provided to cancel the appointment. Option 1306 is provided to notify the financial institution that the customer has arrived for the appointment 1302.

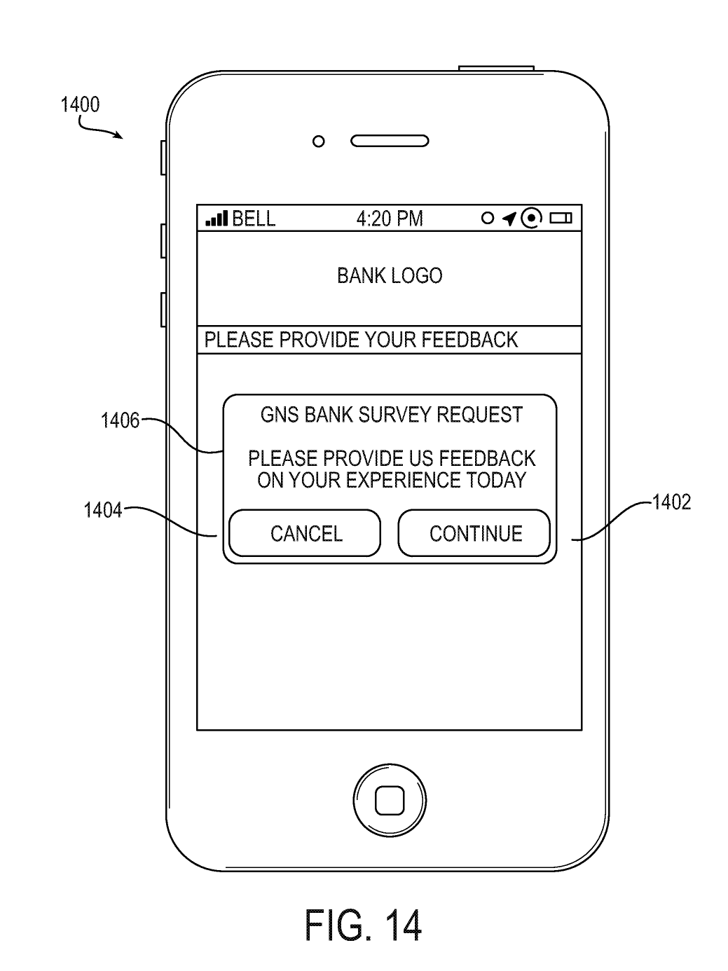

FIG. 14 illustrates an example of a user interface 1400 for requesting a survey for an appointment. The user interface 1400 comprises a notification 1406 along with an option 1402 to take the survey and an option 1402 to cancel.

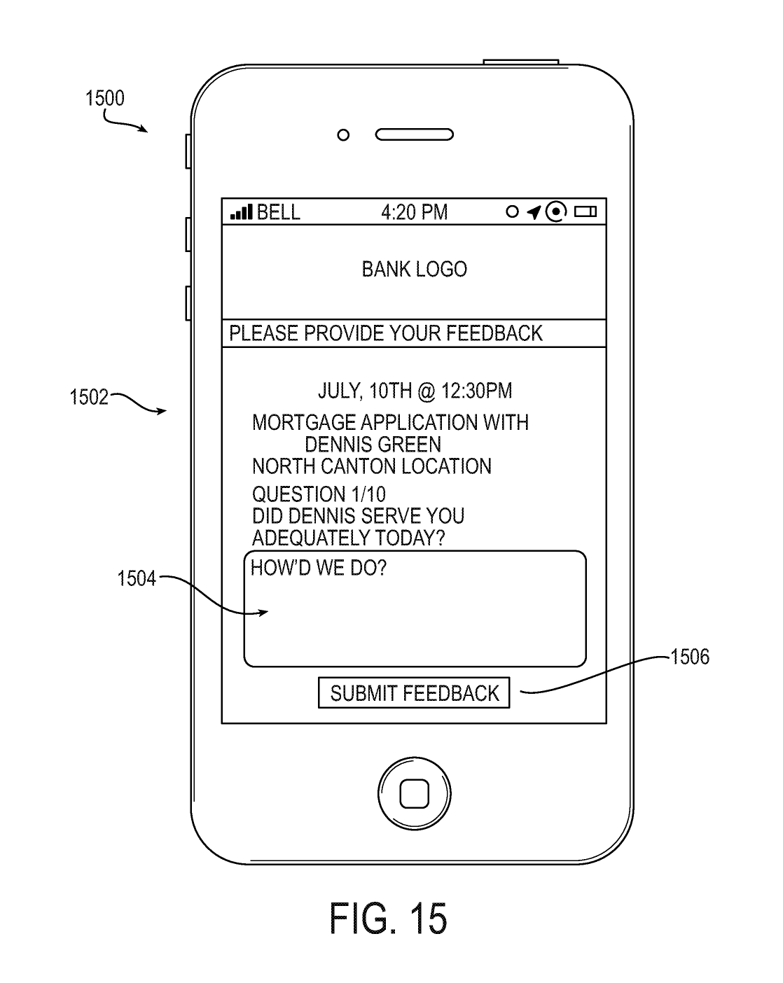

FIG. 15 illustrates an example of a user interface 1500 for responding to a survey. Data representative of the appointment 1502 is displayed along with an area 1502 where the user can add comments. Option 1506 is employed to send the comments to the financial institution.

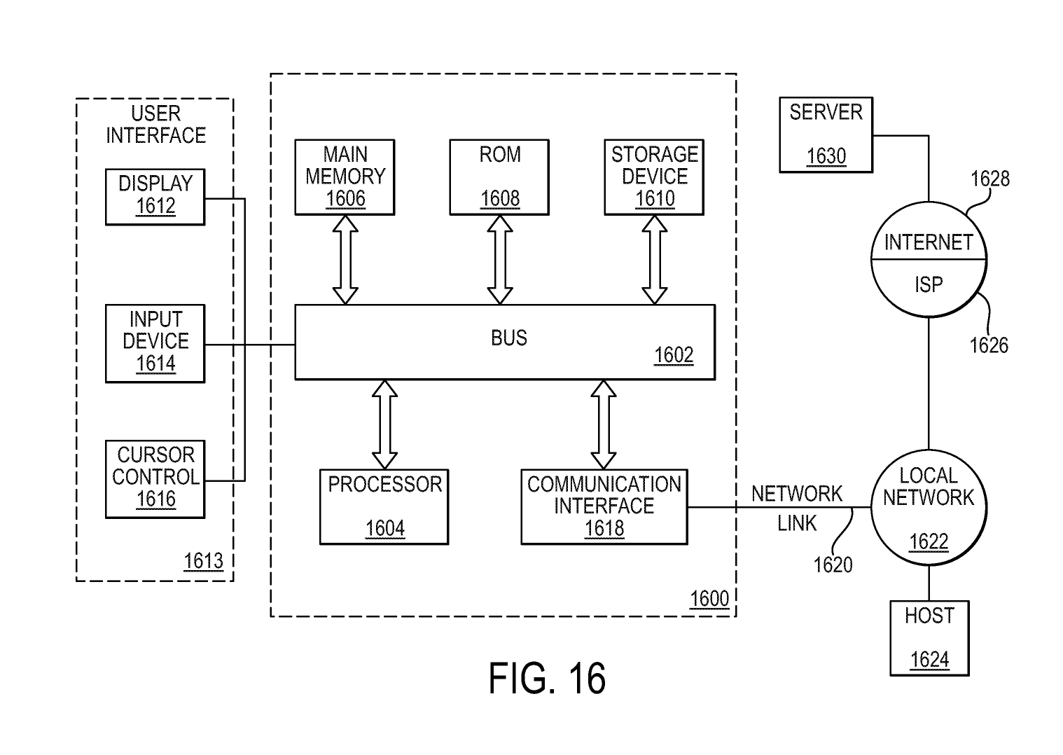

FIG. 16 is a block diagram illustrating an example of a computer system 1600 upon which an example embodiment may be implemented. In an example embodiment, computer system 1600 may be employed to implement consumer calendar logic 204 (FIG. 2). In another example embodiment, computer system 1600 may be employed to implement financial institution calendar logic 302 (FIG. 3).

Computer system 1600 includes a bus 1602 or other communication mechanism for communicating information and a processor 1604 coupled with bus 1602 for processing information. Computer system 1600 also includes a main memory 1606, such as random access memory (RAM) or other dynamic storage device coupled to bus 1602 for storing information and instructions to be executed by processor 1604. Main memory 1606 also may be used for storing a temporary variable or other intermediate information during execution of instructions to be executed by processor 1604. Computer system 1600 further includes a read only memory (ROM) 1608 or other static storage device coupled to bus 1602 for storing static information and instructions for processor 1604. A storage device 1610, such as a magnetic disk or optical disk, is provided and coupled to bus 1602 for storing information and instructions.

In an example embodiment, computer system 1600 be coupled with a user interface 1603 that comprises a display 1612, input device 1614, and cursor control 1616. The computer system 1600 may be coupled via bus 1602 to the display 1612 such as a cathode ray tube (CRT) or liquid crystal display (LCD), for displaying information to a computer user. The input device 1614, such as a keyboard including alphanumeric and other keys is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g. x) and a second axis (e.g. y) that allows the device to specify positions in a plane. Those skilled in the art should readily appreciate that other input/output devices such as audio devices may also be employed.

An aspect of the example embodiment is related to the use of computer system 1600 for financial institution calendaring. According to an example embodiment, financial institution calendaring is provided by computer system 1600 in response to processor 1604 executing one or more sequences of one or more instructions contained in main memory 1606. Such instructions may be read into main memory 1606 from another computer-readable medium, such as storage device 1610. Execution of the sequence of instructions contained in main memory 1606 causes processor 1604 to perform the process steps described herein. One or more processors in a multi-processing arrangement may also be employed to execute the sequences of instructions contained in main memory 1606. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 1604 for execution. Such a medium may take many forms, including but not limited to non-volatile media. Non-volatile media include for example optical or magnetic disks, such as storage device 1610. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 1600 also includes a communication interface 1618 coupled to bus 1602. Communication interface 1618 provides a two-way data communication coupling computer system 1600 to a network link 1620 that is connected to a local network 1622. For example, communication interface 1618 may be a local area network (LAN) card to provide a data communication connection to a compatible LAN. As another example, communication interface 1618 may be an integrated services digital network (ISDN) card or a modem to provide a data communication connection to a corresponding type of telephone line. Wireless links may also be implemented. In any such implementation, communication interface 1618 sends and receives electrical, electromagnetic, or optical signals that carry digital data streams representing various types of information.

Network link 1620 typically provides data communication through one or more networks to other data devices. For example, network link 1620 may provide a connection through local network 1622 to a host computer 1624 or to data equipment operated by an Internet Service Provider (ISP) 1626. ISP 1626 in turn provides data communications through the worldwide packet data communication network, now commonly referred to as the “Internet” 1628.

In accordance with at least one example embodiment, not all features described in FIG. 16 are required. For example, if computer system 1600 is being employed to implement financial institution calendar logic 302 (FIG. 3), the user interface 1613 may not be included. The server 1630 illustrated in FIG. 16 may correspond to the consumer device 102 (FIG. 1) and the Host 1614 may be employed by the calendar application 306 (FIG. 3). However, if the computer system 1600 is employed to implement a consumer device, the user interface 1613 would be included and the server 1630 may correspond to the financial institution scheduling service 104 (FIG. 1).

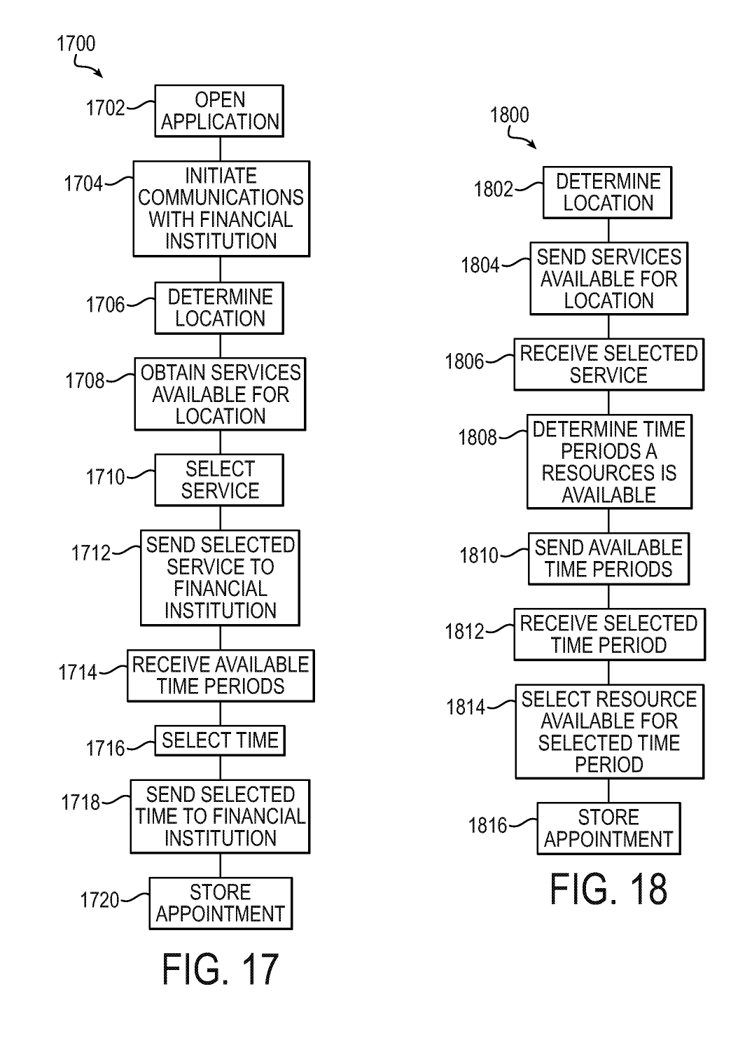

In view of the foregoing structural and functional features described above, methodologies in accordance with example embodiments will be better appreciated with reference to FIGS. 17 and 18. While, for purposes of simplicity of explanation, the methodologies of FIGS. 17 and 18 are shown and described as executing serially, it is to be understood and appreciated that the example embodiments are not limited by the illustrated orders, as some aspects could occur in different orders and/or concurrently with other aspects from that shown and described herein. Moreover, not all illustrated features may be required to implement the methodologies described herein. The methodologies described herein are suitably adapted to be implemented in hardware, software when executed by a processor, or a combination thereof.

FIG. 17 is a block diagram illustrating an example of a methodology 1700 performed by a consumer device for scheduling an appointment with a resource at a financial institution. The methodology 1700 may be employed by any of consumer device 102 (FIG. 1) consumer calendar logic 204 (FIG. 2), IOS devivce 506A (FIG. 5), ANDROID device 506B (FIG. 5), bank website 506C (FIG. 5), ATM 506D (FIG. 5) or computer system 1600 (FIG. 16).

At 1702, a user opens an application. The application may reside on a consumer device which may be any suitable device for communicating with a financial institution scheduling system, such as, including but not limited to, a personal computer, a laptop computer, PDA, tablet, smart phone, etc.

At 1704, communications with the financial institution are established. The communication may be established on one or more wired links, one or more wireless links, or a combination of wired and wireless links.

At 1706, the location for the appointment is determined. In an example embodiment, a location is stored, however, an option can be provided to allow the location to be changed. In another example embodiment, the financial institution provides a list of locations, which may be sorted or limited as needed, e.g., branches within a predetermined radius, branches in a zip code or adjacent zip codes, branches near the location of the device implementing the methodology 1700 which can be determined via GPS.

At 1708, a list of available services for the selected location is obtained. For example, the selected location may be sent to the financial institution with a request to provide available services the selected location.

The list of available services may be output on a device to allow the user to select a service. At 1710, the service is selected. At 1712 the data representative of the selected (requested) is sent service to the financial institution.

At 1714, a time or plurality of times a resource is available for the requested service is received from the financial institution. The time or plurality of times may be output on an output device to allow selection of a time.

At 1716 a time for the appointment is selected. The time for the appointment is selected from the time or plurality of times sent by the financial institution. At 1718, data representative of the selected times is sent to the financial institution.

At 1720, application data representative of the selected times for the requested service at the selected location for the scheduled appointment is stored. In an example embodiment, the data may be stored in a store that is associated with a calendaring application. For a .ics file may be sent. Reminders may also be stored.

FIG. 18 is a block diagram illustrating an example of a methodology 1800 performed by a financial institution for scheduling an appointment with a resource at a financial institution. The methodology 1800 may be implemented by any of financial institution scheduling service 104 (FIG. 1), financial institution calendar logic 302 (FIG. 3), Advanced Services Platform 508 (FIG. 5) or computer system 1600 (FIG. 16).

At 1802, a selected location for an appointment is determined. The selected location may be received from the consumer as a default choice. In an example embodiment, the financial institution may provide a list of available locations and wait for the selection of a location.

At 1804, data representative of available services for a selected location is sent to the consumer device. At 1806, obtain data representative of a requested financial service that was selected from the data representative of the available services for the selected location from the consumer device is received.

At 1808, times when a resource is available for the requested service at the selected location are determined. In particular embodiments, times for a plurality of resources that can provide the requested service at the selected location are determined. At 1810, the available times for the requested service are sent.

At 1812, data representative of a selected time is received. At 1814 a resource that is available to provide the requested service at the selected time and selected location is determined. For example, if a single resource is available, it is selected. If multiple resources are available, one may be selected based on any suitable criterion. For example, the selection may be random, based on a round robin scheme, based on seniority, work load, etc. At 1816, the appointment is stored.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1-19. (canceled)

20. An apparatus, comprising:
a communication interface;
a financial institution calendar logic coupled with the communication interface;
the financial institution calendar logic is operable to communicate with a consumer device to schedule an appointment for a resource via the communication interface for a requestor associated with the consumer device;
the financial institution calendar logic is operable to send data representative of available services for a selected location to the consumer device;
the financial institution calendar logic is operable to obtain data representative of a requested financial service selected from the data representative of the available services for the selected location from the consumer device;
the financial institution calendar logic is operable to determine times when resources are available for the requested service;
the financial institution calendar logic is operable to send data representative of the times when resources are available to the consumer device;
the financial institution calendar logic is operable to obtain from the consumer device data representative of a selected time for the requested service;
the financial institution calendar logic is operable to select a selected resource for the requested service at the selected time and schedule the appointment with the selected resource for the requested service at the selected time and the requestor;
the financial institution calendar logic is operable to store in a calendar application for the selected resource data representative of the appointment;
the financial institution calendar logic is operable to receive via the communication interface from a wireless device associated with the requestor data indicating that the requestor has arrived for the appointment; and
the financial institution calendar logic is responsive to receiving the data indicating that the requestor has arrived to send, via the communication interface, data indicating that the requestor has arrived to the selected resource.

21. The apparatus set forth in claim 20, further the financial institution calendar logic is further operable to:
automatically select the selected resource from a plurality of resources available for the requested service during the selected time;
wherein the selected resource is selected from the plurality of resources available based on seniority.

22. The apparatus set forth in claim 20, further comprising the financial institution calendar logic is operable to send data representative of a plurality of locations associated with the financial institution to the consumer device

23. The apparatus set forth in claim 20, further comprising:
the financial institution calendar logic is operable to receive data indicating a cancelation of the appointment from the consumer device; and
the financial institution calendar logic is operable to remove the appointment from the calendar application in response to receiving the data indicating the cancelation of the appointment from the consumer device.

24. The apparatus set forth in claim 20, further comprising:
the financial institution calendar logic is operable to obtain data representative of notes for the appointment from the consumer device; and
the financial institution calendar logic is operable to associate the data representative of the notes with the appointment to the financial institution.

25. The apparatus set forth in claim 20, further comprising the financial institution calendar logic is operable to send a survey to the consumer device for the appointment.

26. The apparatus set forth in claim 25, further comprising:
the financial institution calendar logic is operable to receive a response to the survey; and
the financial institution calendar logic is operable to store the response.

27. The apparatus set forth in claim 20, further comprising the calendar logic is operable to send confirmation from the financial institution that the appointment has been scheduled.

28. The apparatus set forth in claim 20, wherein the available services comprise at least one of a group consisting of mortgages, car loans, and investment advice.

29. An apparatus, comprising:
a communication interface;
a financial institution calendar logic coupled with the communication interface;
the financial institution calendar logic is operable to communicate with a consumer device to schedule an appointment for a resource via the communication interface for a requestor associated with the consumer device;
the financial institution calendar logic is operable to send data representative of available services for a selected location to the consumer device;
the financial institution calendar logic is operable to obtain data representative of a requested financial service selected from the data representative of the available services for the selected location from the consumer device;
the financial institution calendar logic is operable to determine times when resources are available for the requested service;
the financial institution calendar logic is operable to send data representative of the times when resources are available to the consumer device;
the financial institution calendar logic is operable to obtain from the consumer device data representative of a selected time for the requested service;
the financial institution calendar logic is operable to automatically select the selected resource from a plurality of resources available for the requested service during the selected time and schedule the appointment with the selected resource for the requested service at the selected time and the requestor;
the financial institution calendar logic is operable to store in a calendar application for the selected resource data representative of the appointment; and
the financial institution calendar logic is operable to send data representative of the appointment
wherein the selected resource is selected from the plurality of resources available based on seniority.

30. The apparatus set forth in claim 29, further comprising the financial institution calendar logic is operable to send data representative of a plurality of locations associated with the financial institution to the consumer device

31. The apparatus set forth in claim 29, further comprising:
the financial institution calendar logic is operable to receive data indicating a cancelation of the appointment from the consumer device; and
the financial institution calendar logic is operable to remove the appointment from the calendar application in response to receiving the data indicating the cancelation of the appointment from the consumer device.

32. The apparatus set forth in claim 29, further comprising:
the financial institution calendar logic is operable to obtain data representative of notes for the appointment from the consumer device; and
the financial institution calendar logic is operable to associate the data representative of the notes with the appointment to the financial institution.

33. The apparatus set forth in claim 29, further comprising the financial institution calendar logic is operable to send a survey to the consumer device for the appointment.

34. The apparatus set forth in claim 33, further comprising:
the financial institution calendar logic is operable to receive a response to the survey; and
the financial institution calendar logic is operable to store the response.

35. The apparatus set forth in claim 29, further comprising the calendar logic is operable to send confirmation from the financial institution that the appointment has been scheduled.

36. The apparatus set forth in claim 29, wherein the available services comprise at least one of a group consisting of mortgages, car loans, and investment advice.
